(19) United States
(12) Patent Application Publication
(10) Pub. No.: US 2012/0320073 A1
(43) Pub. Date: Dec. 20, 2012

(54) Multiple Spatial Partitioning Algorithm Rendering Engine

(75) Inventor: Steven D. Mason, San Francisco, CA (US)

(73) Assignee: Obscura Digital, Inc., San Francisco, CA (US)

(21) Appl. No.: 13/160,385

(22) Filed: Jun. 14, 2011

(51) Int. Cl. G09G 5/00

(52) U.S. Cl. 345/581

(57) ABSTRACT

Methods, apparatuses and systems directed to rendering a large-scale two-dimensional workspace having embedded, potentially overlapping digital objects. The method entails dynamically creating a plurality of region models based on one or more spatial partitioning algorithms to determine first, what portions of the workspace intersect a globally-defined viewport, and second, to determine what portions of objects are occluded by other objects for efficient rendering.

### TECHNICAL FIELD

The present disclosure generally relates to efficiently rendering an effectively infinite two-dimensional workspace having embedded digital objects utilizing spatial partitioning algorithms.

### BACKGROUND

The advent of high capacity display controller memory has allowed users of computing devices to greatly expand their desktop size and resolution. Software for collaborative workspaces, increased display size, and convenient gesture-based navigation continues to drive the demand for increased desktop space upward. Graphical rendering of large two-dimensional regions requires increased display controller processor and memory usage because traditional methods of desktop rendering render the entire workspace, even if the user is viewing only a portion of the workspace, and render portions of the image that are occluded from the user's view.

### SUMMARY

The present disclosure generally relates to efficiently rendering an effectively infinite 2D region, desktop, or workspace through the use of spatial partitioning algorithms. In one embodiment, the rendering engine renders a large-scale 2D desktop or workspace, on the order of acres in effective size, by defining a viewport corresponding to the user's view of the workspace, and rendering only the region of the workspace intersecting the user's viewport. In particular embodiments, the rendering engine supports collaborative viewing and editing of the workspace, and may render a unique viewport for each of a plurality of users.

In particular embodiments, the workspace supports the embedding of digital objects such as photos, videos, documents, or application windows and user interfaces. In particular embodiments, the digital objects may be positioned and resized anywhere on the workspace. In particular embodiments, digital objects may partially or entirely overlap each other and the background of the workspace. In particular embodiments the rendering engine does not render the portions of the background or the digital objects that are occluded by other digital objects. In particular embodiments, the rendering engine assigns a stacking order to each digital object and queries a dynamically generated spatial region model created in accordance with a spatial partitioning algorithm to determine which portions of the background and digital objects are obscured by other digital objects, and prunes the determined portions from the list of regions to be rendered.

In particular embodiments, the large-scale 2D workspace functions as an “infinite digital whiteboard” that permits a number of users to share and collaborate on the workspace. In particular embodiments, the digital whiteboard consists of a whiteboard background canvas comprising a global meta-space. In particular embodiments, the users may populate the digital whiteboard with any number of digital objects as described above. In particular embodiments, users may draw figures, add text, and any other means of free-form strokes on the whiteboard space. In particular embodiments, a user may view a history of the digital whiteboard, and view the whiteboard at any given moment in time, or scrub through the time axis and view the whiteboard's progression substantially in real-time. In particular embodiments, the digital whiteboard is rendered entirely on a server, and the server transmits only draw commands to remote user devices such as personal computers, tablet PCs, mobile phones, and the like.

These and other features, aspects, and advantages of the disclosure are described in more detail below in the detailed description and in conjunction with the following figures.

### BRIEF DESCRIPTION OF THE DRAWINGS

FIG. 1 illustrates an example of a workspace addressed by a quad-tree data structure.

FIG. 2 illustrates an example large-dimension 2D workspace using quad-tree tiles for efficient rendering at various zoom levels.

FIG. 3A illustrates an example 2D workspace indexed via an R-tree spatial partitioning algorithm.

FIG. 3B illustrates the example nodal structure of the R-tree model of FIG. 3A.

FIG. 4 illustrates an example large-scale 2D workspace with embedded digital objects.

FIG. 5 is a flow diagram of an example rendering process in accordance with one embodiment of the invention.

FIG. 6 is flow diagram of an example rendering process for removing occluded regions from the rendering pipeline in accordance with one embodiment of the invention.

FIG. 7 illustrates an example of a computer system.

FIG. 8 illustrates an example network environment.

### DETAILED DESCRIPTION

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Techniques for rendering large area 2D regions are known in the art. Because it is both memory and processor intensive to render large, high resolution images (i.e., at the gigapixel-and-up resolution), techniques that render images at varying resolutions for a given viewable area are commonly utilized. Particular rendering methods store multiple images of the 2D region at different zoom levels, with each image segmented into uniformly-sized tiles. In particular implementations, such as Google Maps, the large-area 2D region is indexed via a quadtree data structure. Quadtrees are data structures in which each internal node has exactly four children. The region quadtree represents a partition of space in two dimensions by decomposing the region into four equal quadrants, subquadrants, and so on. Each node has either exactly four children or has no children (also called a leaf node). In 2D image rendering, leaf nodes generally represent the individual tiles as the highest (most zoomed in) detail level. Quadtree spatial partitioning and image indexing techniques are well-known in the art.

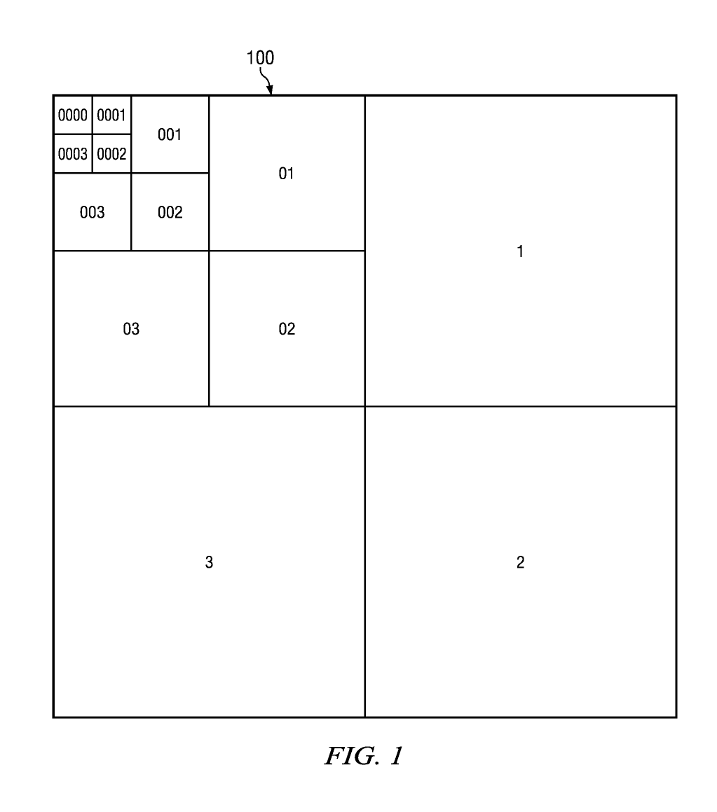

FIG. 1 illustrates an example of a 2D desktop or workspace addressed by a quad-tree data structure. In particular embodiments, workspace 100 may be sized on the order of several acres, having an area approaching trillions of square pixels. Thus, the 2D workspace may be considered effectively infinite from the user's perspective, even when considering the viewing display device can be as small as a small portable handheld device to even the size of an entire wall of a room. Quadtree indexing utilizes a quadtree data structure, which uses quaternary bits, the values 0, 1, 2, 3, and 4 representing the quadrants of a two dimensional space. For example, at the most significant bit level, or the “root node”, the entire workspace 100 is segmented into four regions. At the next most significant bit level, each quadrant is segmented into another 4 regions, and so on, so that workspace 100 is segmented into 4̂n tiles, where n=the number of bits in the indexing system. For example, workspace 100 in FIG. 1 possesses 4 levels, and thus is divided into 256 uniformly sized tiles, with the address “0000” referring to the top left tile.

In particular embodiments, the tile may be of any arbitrary dimension, such as 256×256 pixels. In particular embodiments, the tile size is sufficiently small so that tiles may be transmitted and rendered quickly. Although not shown in FIG. 1 for the sake of clarity, it is understood that quadrants 1, 2, 3, 01, 02, and 03, and their subquadrants are divided in the same manner. Furthermore, although FIG. 1 only depicts 4 levels, particular embodiments of the invention may have any number of levels and tile size, such as 12-bit depth and 256 pixel tiles, resulting in a 4,284,867,286 pixel×4,284,867,286 pixel workspace. Tiles at the least significant digit comprise the smallest units of the quad-tree spatial partitioning system. Thus individual pixels within a bitmap of the standard tile size (again, for example 256×256) are generally addressed via Cartesian coordinates.

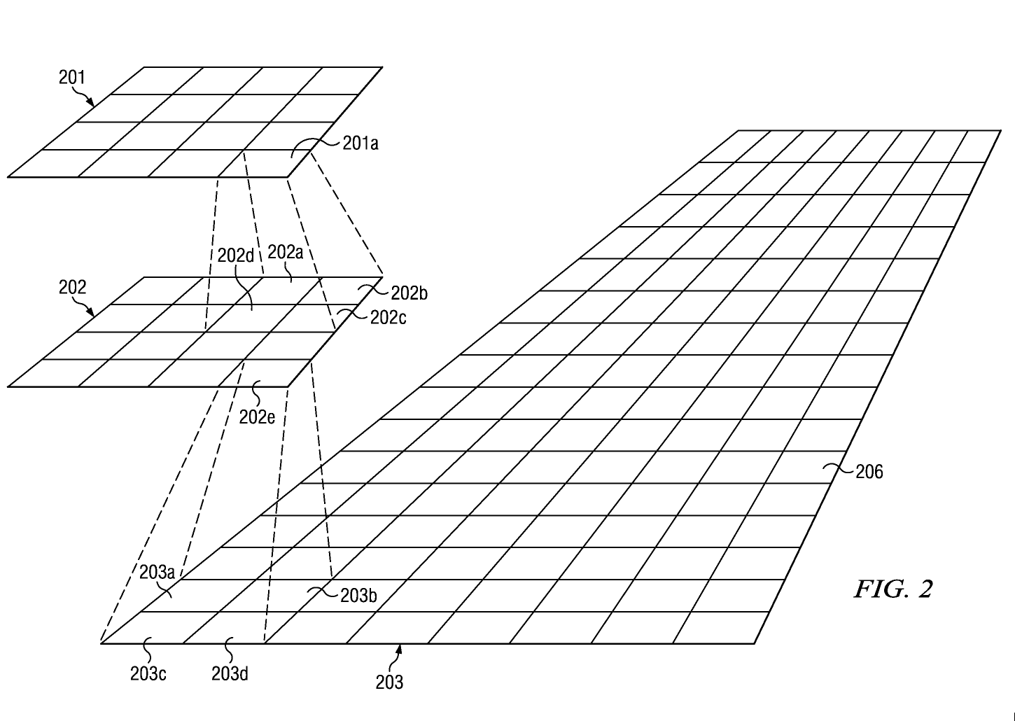

FIG. 2 illustrates, for didactic purposes, a 2D workspace partitioned by quadtree regions with three separate images 201, 202, and 203, each representing a different zoom level or level of detail. Image 201 represents an image at a low level of detail (i.e., “zoomed out”) near the root node. In this example, n=2, and the image is segmented into 16 uniformly sized tiles. Because the tiles are uniformly sized, and the display area is constrained by the dimensions of the user's display or view, the total viewable area of the image decreases as the level of detail, or the “zoom level”, increases. Image 202 represents an image having a medium level of detail at n=3, where each tile from image 201 is segmented into four tiles having the same dimensions as the tiles in 201. For example, the image area represented by, for example, 256×256 tile 201a is rendered as 1024×1024 tiles 202a, 202b, 202c, and 202d in image 202. Similarly, image 203 represents an image with a high level of detail at n=4. For example, the image area covered by tile 202e is represented by tiles 203a, 203b, 203c, and 203d. Consequently, an image area represented by a 256×256 pixel tile in image 201 occupies 4086×4086 pixels in image 203.

In this manner, a user who wishes to view a zoomed out, low-detail image area does not have to download a high-resolution representation of the area, thereby saving bandwidth. The quad-tree image indexing also allows the system to efficiently determine which tiles to load when a user decides to zoom in on a particular area, thereby reducing bandwidth consumption. Such methods of storing multiple resolution versions of a large image are well-known in the art, such as those utilized in creating gigapixel mosaic images. Although this example describes three images representing three sequential n-value zoom levels, this disclosure contemplates any number of images representing any number of non-sequential n-value zoom levels.

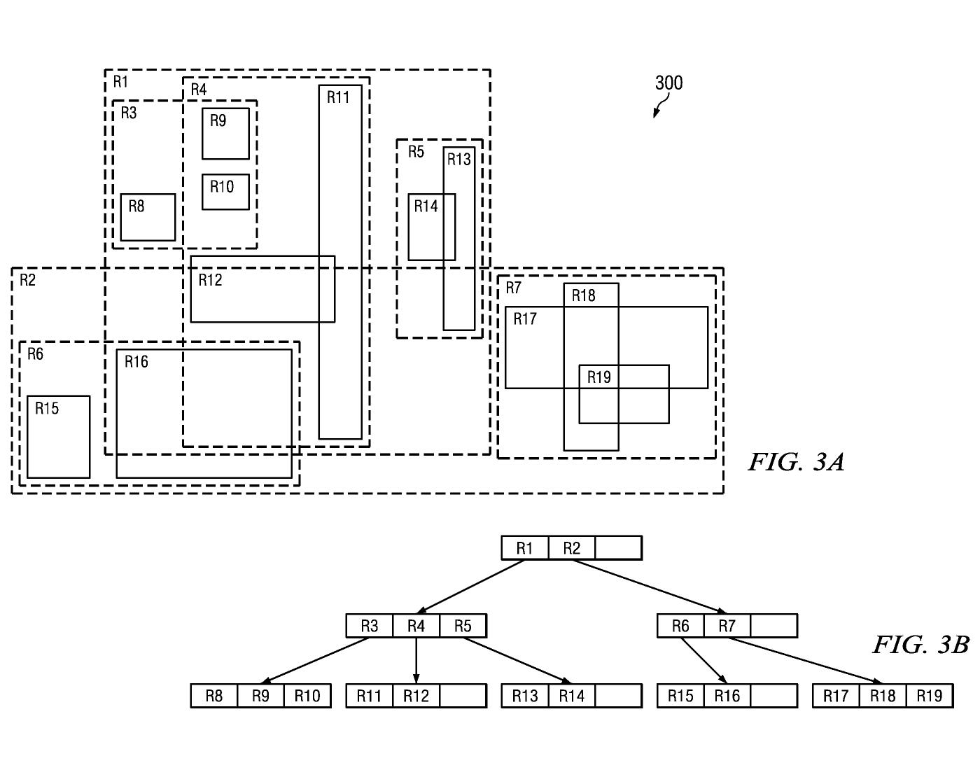

R-tree spatial partitioning is another known algorithm for handling large scale or map-like displays. FIG. 3A depicts an example 2D workspace indexed via an R-tree spatial partitioning algorithm. The R-tree structure splits 2D workspace 300 with hierarchically nested, and possibly overlapping, minimum bounding rectangles (MBRs) R1-R18. Each node of an R-tree has a variable number of entries, and each entry within a non-leaf node (nodes that contain child nodes) stores two pieces of data: a way of identifying a child node, and the bounding box of all entries within the identified child node. Because each region is defined by its bounding box, the R-tree model may quickly determine whether nodes are overlapping and to what extent they overlap. R-tree spatial partitioning algorithms are well-known in the art.

FIG. 3B depicts the nodal structure of the R-tree illustrated in FIG. 3A. The largest regions, R1 and R2, overlap, but neither region is fully contained in the other, and hence the two regions are placed on the same hierarchical level. R1 includes regions R3, R4, and R5, which similarly overlap but lack any single regain fully contained in another. As such R3, R4, and R5 are placed on the same hierarchical level as child nodes to R1. R3 includes three child leaf nodes fully contained in its bounding box, R8, R8, and R10. Thus, the R-tree spatial model may quickly ascertain whether any two regions are overlapping through a simple query of the nodal structure.

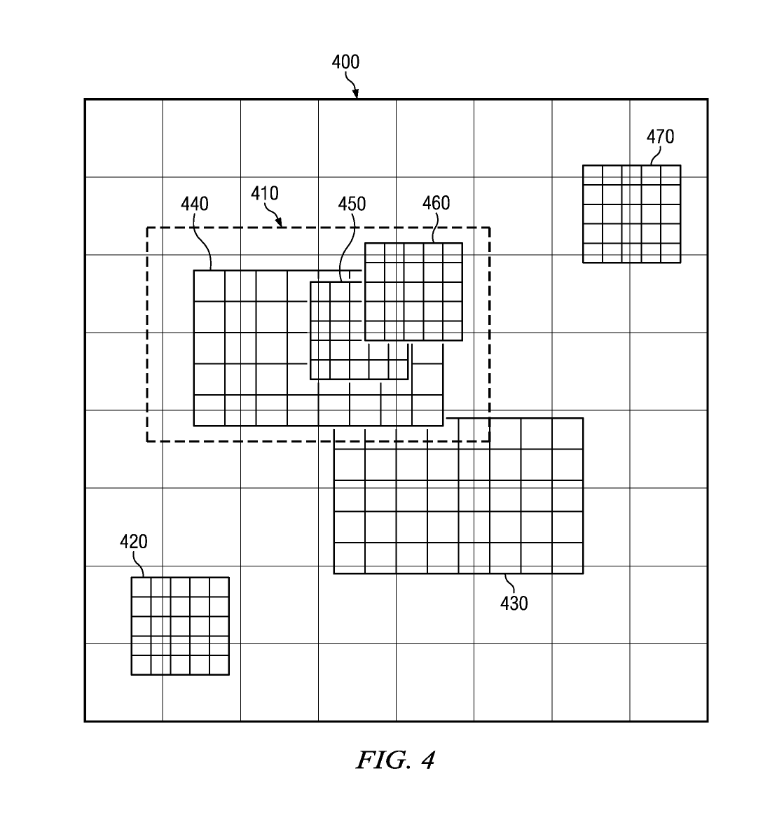

FIG. 4 depicts an example large-scale 2D workspace with embedded digital objects. In particular embodiments, workspace 400 is segmented into quad-tree tiles and is tile-addressable as described above. In particular embodiments, workspace 400 is segmented via Cartesian coordinates and addressable in the same manner. This disclosure contemplates any manner of spatial indexing. Viewport 410 defines the portions or tiles of workspace 400 to be rendered on the display of a particular user. Viewport 410 may change depending on the user's desired zoom level and positioning. For example, in particular embodiments, where the user desires to view a “global” view of viewport 400, viewport 410 may completely cover viewport 400. Additionally, the user may position viewport 400 via a panning operation on his or her computing device. In particular embodiments, the user utilizes a touchscreen device, and panning is achieved through a swipe gesture, while zooming is achieved through a pinch gesture.

Workspace 400 may include a plurality of embedded digital objects 420-470. Although digital objects 420-470 are embedded in workspace 400, nonetheless the background of workspace 400 may be partially or totally occluded by one or more digital objects 420-470. In particular embodiments, the background of workspace 400 is considered the lowest layer of workspace 400; no objects may be placed below the background nor be obscured, covered, or occluded by the background.

In particular embodiments, digital objects 420-470 may be added, positioned, and resized by one or more users of workspace 400. Digital objects 420-470 may be any object that may be rendered on workspace 400, including but not limited to photos, documents, 3D models, video clips, icons representing sound clips, application windows, shortcuts to locations or applications, icons representing file locations or directories, and the like. In particular embodiments, digital objects 420-470 may be application user interfaces such as menus, graphical user interfaces, controls, and the like. This disclosure contemplates any suitable type of digital objects 420-470.

Digital objects 420-470 may be stacked on top of each other, partially or completely obscuring underlying objects. Each digital object or region associated with a digital object may be assigned a stacking order to instruct the rendering engine whether to render the digital object. For example, assuming the background of workspace 400 is assigned a stacking order of “0”, object 430 would be assigned a stacking order of “1”, object 440 a stacking order of “2”, 450 a stacking order of “3”, and object 460 a stacking order of “4.” Thus where an object is partially or totally occluded by an object with a higher stacking order, the rendering engine knows that it does not need to render the occluded portions, thereby drastically reducing the processing needed to render viewport 410. In the example of FIG. 4, the rendering engine determines it needs to only render the background tiles included in viewport 410, less the background tiles that are covered by objects 430, 440, 450, and 460, along with the uncovered tiles of digital objects 430-460.

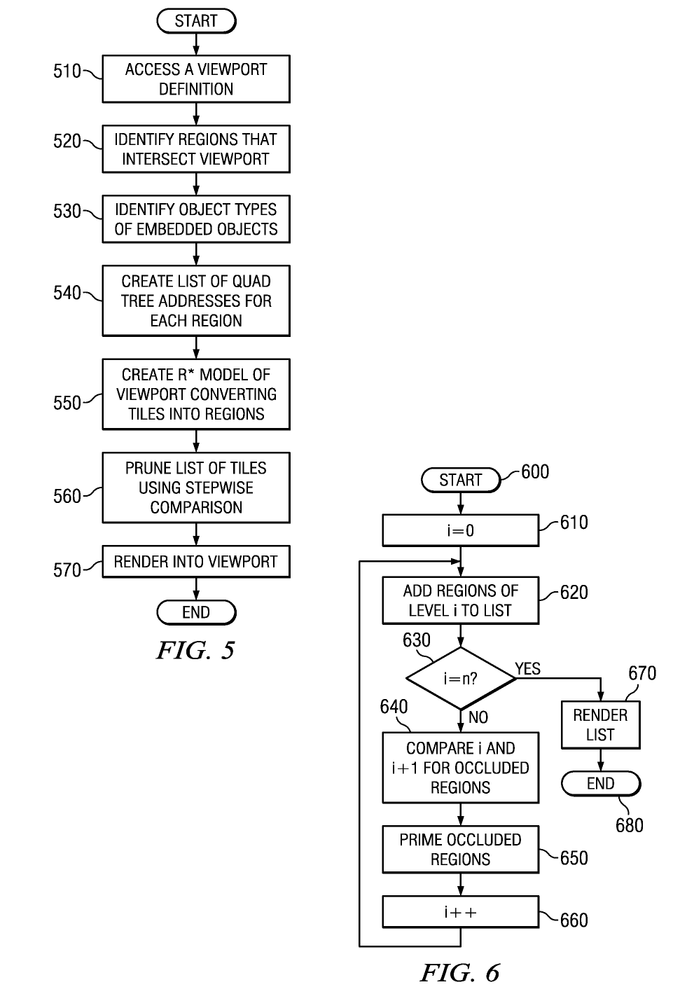

FIG. 5 is a flow chart of an example method of rendering workspace 400 for a particular viewport 410. At Step 510, the rendering engine accesses a viewport definition for viewport 410. In particular embodiments, the viewport is expressed in terms of global coordinates for the highest level pixel space. For example, because the viewport is unlikely to fall upon the exact borders of a particular set of tiles, viewport 410 may be defined in terms of x and y coordinates at the highest pixel level space, or the most detailed level of the workspace. In particular embodiments, the viewport window is defined by two sets of (x,y) coordinates corresponding to two opposing corners of viewport 410. In particular embodiments, a point quadtree may be utilized to define viewport 410. In particular embodiments, the user's client device includes pre-set, selectable zoom levels, and the device translates the combination of a corner coordinate, zoom level, and the size of the client device's display resolution to a set of global x,y coordinates. This disclosure contemplates any suitable method of defining viewport 410.

At Step 520, the rendering engine identifies regions of workspace 400 that intersect viewport 410. In particular embodiments, an R* tree is utilized to determine what regions of workspace 400 intersect with viewport 400. The R* tree differs from R-trees by utilizing a revised node split algorithm and forced reinsertion at node overflow to reduce coverage and overlap. The R* tree is well-known in the art, and existing R* tree functions may be utilized to query any R* region model to determine whether particular regions are included in a defined area. In particular embodiments, Step 520 is repeated any time viewport 410 is moved, scaled, or otherwise altered.

In particular embodiments, the detected regions include the regions of the global meta-space of workspace 400 as well as the regions of individual objects embedded in the meta-space intersecting the bounding box of viewport 400. As discussed earlier, digital objects may be anything that exists in the space, such as images, videos, media players, application user interfaces, and the like. In particular embodiments, the background of workspace 400 is also returned as a region. Thus in the example of FIG. 4, the R* region model is created at step 510 for the entire workspace 400 and a query is issued to the region model having the region node corresponding to viewport 410 as an input parameter. The R* model then returns the regions corresponding to the tiles of the background overlapping region 410, as well as region nodes corresponding to digital objects 430, 440, 450, and 460. This occurs any time the viewport changes; the R* tree returns the objects which overlap the viewport region in any way.

At Step 530, the rendering application determines what types of objects are returned by the region model. In particular embodiments, objects that are images are partitioned into their own quad-tree rendering space. For example, digital object 440 may be a digital image that is segmented into quad-tree tiles, wherein each individual tile of object 440 is addressable by a quad-tree address. In particular embodiments, the digital objects are addressed and segmented in other methods. This disclosure contemplates any manner of spatial partitioning suitable for partitioning and addressing digital objects 420-470.

At Step 540, the rendering application generates a list of quad-tree addresses for all the tiles pertinent to viewport 410. A list of addresses is generated for each pertinent region identified in Step 520. Thus, in the example of FIG. 4, a list of quad-tree addresses is generated for each of the background of workspace 400 and each of digital objects 430-470. Each address in a list corresponds to the component tiles in the region. For example, in FIG. 4, the list of addresses for digital objects 440-460 would include all the tiles of the regions, whereas the list generated for digital object 430 would only include quad-tree addresses identifying the tiles of object 430 that fall within the bounding box of viewport 410. As stated, digital objects may be partitioned, segmented, and addressed in any suitable manner. For example, regions may be partitioned via binary trees (B-Trees), R+ Trees, Hilbert R-Trees, Priority R-Trees (PR-Trees), Z-order, octree, X-Tree, KD-Tree, M-tree, UB-Tree, and the like. This disclosure contemplates generating a list of component addresses for any type of spatial partitioning algorithm.

At Step 550, the rendering engine creates a new instance of the R* tree model, converting each tile represented by the list of addresses created in the previous step as a separate region. In the example of FIG. 4, an R* tree model of viewport 410 is created having a region for each of the tiles of the background intersecting viewport 410, each of the tiles of digital objects 440, 450, and 460, whether occluded or not, and each of the set of the tiles of object 430 intersecting viewport 410. During the creation of this R*-Tree model, the boundary definitions of the pertinent objects are also created for the purpose of determining whether regions are overlapping. In particular embodiments, Step 550 is repeated any time an object is inserted, deleted, moved, or scaled.

The dynamically-created R* model created in Step 540 is completely unrelated to the R* model created in Step 520. In particular embodiments, the models created in Steps 520 and 540 do not utilize the same spatial partitioning algorithm. In particular embodiments, the first model utilizes a B-tree and the second model utilizes an R-tree. In particular embodiments, the viewport may be defined by quad-tree tiles. This disclosure contemplates any appropriate combination of spatial partitioning algorithms.

At Step 560, the rendering application prunes the list of tiles to be rendered on the user display. This step saves processing power by removing from the rendering pipeline regions that are occluded by other objects. For example, in FIG. 4, there is no need for the rendering engine to draw the tiles of the background of workspace 400 that are covered by digital objects 430-470, nor to draw the tiles of 430, 440, or 450 that are obscured by overlying objects. In particular embodiments, iterative queries to the R* tree model generated in Step 550 are utilized to prune the list of tiles to be rendered. This process is described in greater detail with reference to FIG. 6.

At Step 570, the rendering application renders the pruned list of tiles into the display of the user viewing viewport 410. In particular embodiments, the rendering application is hosted on a remote server, and renders viewport onto a local machine. In particular embodiments, the rendering engine transmits a quad-tree address for a stored object to the client device, which fetches the underlying asset and renders the tiles itself. In particular embodiments, the local user interacts directly with the machine on which the rendering engine resides. In particular embodiments, the rendering server transmits draw commands to a graphics application program interface (API) on a client machine. In particular embodiments, the rendering application renders directly into raster data, and transmits raw raster data to a thin client device lacking a powerful graphics rendering processor. In particular embodiments, the rendering application itself may be distributed among multiple client or server machines. In particular embodiments, the client is implemented purely in HTML or another markup language, and all the rendering is performed off-client. This disclsoure contemplates any arrangement of computing devices for rendering and displaying a viewport of a large-scale 2D region to one or more users.

FIG. 6 is flow diagram of the example rendering process of Step 560. Each region of the R*-tree model created in Step 550 includes a stacking order indicating its position relative to other objects in the Z-dimension. For example, in particular embodiments, the background of workspace 400 is assigned a stacking order of “0”; the background cannot occlude, or be placed “above” any digital object. In particular embodiments, the stacking order for each individual region of the R* tree is obtained by the list of quad-tree addresses. Each list is associated with a digital object in viewport 410 having a stacking order, and consequently each one of its constituent tiles or components inherits the stacking value. In particular embodiments, the stacking order is simply determined by the relative area covered by each object. For example, objects covering a larger number of pixels may be automatically assigned lower stacking orders.

The process begins at Step 610 with regions with the lowest stacking order, the regions comprising the background of workspace 400. In this example, the regions with the lowest stacking order are assigned a value of “0”, however, this disclosure contemplates any manner of assigning stacking orders to regions. At Step 610, the rendering engine creates a list of regions (at this point, the regions correspond to the quad-tree tiles) to be rendered. In particular embodiments, the list begins in an unpopulated state.

At Step 620, the rendering engine adds the regions of the current level or layer to the list. Thus, when i=0, all the regions, comprising the tiles of the background of workspace 400, are added to the list of regions to be rendered.

In Step 630, the rendering engine checks whether the current level is the highest stacking order level. If so, the process ends and proceeds to render the list of tiles into the viewport at Step 670. If not, the process proceeds to Step 640.

At Step 640, the rendering engine issues a query to the R*-Tree model using pre-existing model tools to determine what regions of the current level are occluded by regions of the immediately overlying level. For example, the rendering engine issues a query to the R*-Tree model to determine what regions (corresponding to individual tiles) of the background of workspace 400 are occluded or overlapping with regions having a stacking order of 1. The R*-tree region model returns, as an output, the regions of the background of the workspace 400 that are covered by regions of the digital object 440. The R*-Tree calculates the occluded regions through the use of the bounding boxes of each region added at the time of creation of the region model.

At Step 650, the rendering engine prunes the occluded regions corresponding to individual tiles of the background of workspace 400 determined in Step 640 from the list of regions to be rendered. The process then increments the current level to the next level at Step 650, and loops back to Step 620. This loop continues until the current level is the uppermost level in viewport 410, at which the entire scene is rendered in Step 670. In pseudo-code, the method of FIG. 6 may be represented as a for loop:

for (i=0; i=n; i++) {
add regions(i); //add regions to list
x=compare(i, i+1); //find regions of i occluded by regions of i+1
remove(x);}//remove regions in set x from the list

Utilizing the method of FIG. 6, the list to be rendered comprises an efficient list of tiles (or other spatial partitioning addresses) and their x, y position on the screen, allowing the rendering engine on a server or a client to draw viewport 410 with minimal processing. In particular embodiments, each tile could simply be addressed by a variable [(x,y), (quad-tree address), (name of object)] which may be quickly fetched by a rendering application. In particular embodiments, the tile assets are each stored in an individual directory path, and a simple stream manipulation may be utilized to quickly translate the variable described above to a directory path in order to fetch a particular tile. In particular embodiments, each object is stored in a directory with sub-directories for each quad-tree bit. For example, if a digital object with the name “Document 1” exists within the global meta-space, it is stored in a directory path “C:\ . . . \Document 1\” having sub folders 0, 1, 2, and 3. Each of the subfolders will, in turn, have another set of subfolders 0-3, continuing for as many n-levels of the object. For example, an individual tile of an object having four quad-tree levels might be stored as “C:\ . . . \Document 1\0\2\3\tile.jpg.”

In particular embodiments, each individual tile is stored as a plurality of time-stamped versions, allowing a user to view the modification and progression of workspace 400. In the above example, a tile might be stored as the file: ““C:\ . . . \Document 1\0\2\3\tile_{—}2011_{—}05_{—}27_{—}23:41.093.” In particular embodiments, each object directory also includes a transform directory that has a catalogued, time-stamped, binary file representing the position and sizing of an object. In particular thin-client embodiments, such as pure HTML implementations, the server pulls the tile assets, and transmits them to the client device along with an x,y position. Thus thin-clients only need to be able to render downloaded pictures to render viewport 410.

In particular embodiments, users may draw or mark-up the background or digital objects embedded within the global meta-space of workspace 400. Rendering a stroke does not invoke the processes of FIG. 5 or 6, because no viewport definition has changed, nor has any object sizing or position been altered. In particular embodiments, users may draw a stroke using their finger, mouse, tablet, stylus, or any other input utensil. This disclosure contemplates any manner of user input for drawing on workspace 400.

In particular embodiments, when a user draws a stroke, the rendering engine determines which tiles occupy the pixel positions making up the stroke, and draws them into the tiles by directly writing the pixels into the background or object tiles. In particular embodiments, the pixels are stored as a layer over the bitmapped tile. Thus, regardless of the method used, when a user draws a stroke over an object, the stroke is embedded into the object and is locked to the object regardless of its position or sizing. In particular embodiments, drawing a stroke over a tile creates a new version of the tile with a time stamp, allowing users to view the tile or object at a particular point in time, or “scrub through” the history of the object as previously discussed.

In particular embodiments, when a remote user draws a stroke on workspace 400, a the resulting raster data is stored at the server as described above. However, it is non-ideal for a user to have to wait for the server to render, store, and retransmit the modified tile back to the user. Such an operations reduces the real-time feel of the stroke operation. Thus, in particular embodiments, client drawing the stroke commits the stroke information to the texture that is loaded in their video buffer so that the user may see the stroke instantaneously. The client renders the local version for display only, using the exact same algorithm the server uses to draw stroke pixels into a tile, and notifies the server of the stroke information. The server, in turn, broadcasts any stroke information to all connected clients viewing an area overlapping the tiles in which a user is drawing in, indicating that a specific tile has changed.

This mixture of client and server-side rendering may cause confusing scenarios where multiple users are viewing and modifying the same area of workspace 400. For example, if one user is drawing on a digital object in his viewport, and another user moves the digital object while the first user is drawing a brush stroke, latency between the time the server stores a raster of a modified tile and the time the second user moves the object may result in a user attempting to draw a stroke on an object that is not actually in the same position anymore. The embodiment described in paragraph 0051 alleviates this problem by making the server the ultimate arbiter of all client draw commands. In particular embodiments, positioning or sizing an object locks all its component tiles. Thus, a user drawing onto a tile which is simultaneously being moved or positioned may see his or her local tile updated with the stroke, but will receive a message back from the server indicating that the tile is locked, and the client then must revert back to the previous version of the tile before the action was initiated. In particular embodiments, the client achieves this reversion by re-requesting the tile from the server. In particular embodiments, the client keeps a buffer of tiles in its own memory, and reads out the tile before the event from its own internal buffer. Thus, particular embodiments of the invention avoid activity collision while still providing a sense of immediacy.

Particular embodiments may be implemented as hardware, software, or a combination of hardware and software. For example and without limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

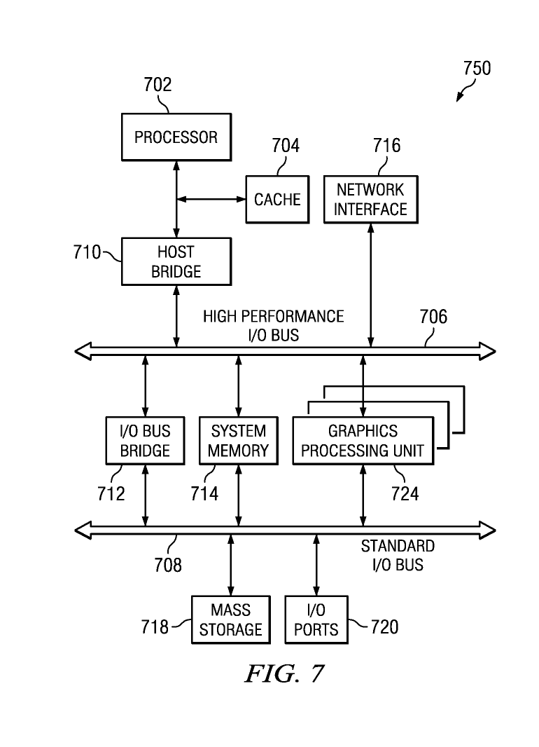

For example, FIG. 7 illustrates an example computer system 700 suitable for implementing one or more portions of particular embodiments. Although the present disclosure describes and illustrates a particular computer system 700 having particular components in a particular configuration, the present disclosure contemplates any suitable computer system having any suitable components in any suitable configuration. Moreover, computer system 700 may have take any suitable physical form, such as for example one or more integrated circuit (ICs), one or more printed circuit boards (PCBs), one or more handheld or other devices (such as mobile telephones or PDAs), one or more personal computers, or one or more super computers.

System bus 710 couples subsystems of computer system 700 to each other. Herein, reference to a bus encompasses one or more digital signal lines serving a common function. The present disclosure contemplates any suitable system bus 710 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 700 includes one or more processors 720 (or central processing units (CPUs)). A processor 720 may contain a cache 722 for temporary local storage of instructions, data, or computer addresses. Processors 720 are coupled to one or more storage devices, including memory 730. Memory 730 may include random access memory (RAM) 732 and read-only memory (ROM) 734. Data and instructions may transfer bi-directionally between processors 720 and RAM 732. Data and instructions may transfer uni-directionally to processors 720 from ROM 734. RAM 732 and ROM 734 may include any suitable computer-readable storage media.

Computer system 700 includes fixed storage 740 coupled bi-directionally to processors 720. Fixed storage 740 may be coupled to processors 720 via storage control unit 752. Fixed storage 740 may provide additional data storage capacity and may include any suitable computer-readable storage media. Fixed storage 740 may store an operating system (OS) 742, one or more executables 744, one or more applications or programs 746, data 748, and the like. Fixed storage 740 is typically a secondary storage medium (such as a hard disk) that is slower than primary storage. In appropriate cases, the information stored by fixed storage 740 may be incorporated as virtual memory into memory 730.

Processors 720 may be coupled to a variety of interfaces, such as, for example, graphics control 754, video interface 758, input interface 760, output interface 762, and storage interface 764, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 756 may couple processors 720 to another computer system or to network 780. With network interface 756, processors 720 may receive or send information from or to network 780 in the course of performing steps of particular embodiments. Particular embodiments may execute solely on processors 720. Particular embodiments may execute on processors 720 and on one or more remote processors operating together.

In a network environment, where computer system 700 is connected to network 780, computer system 700 may communicate with other devices connected to network 780. Computer system 700 may communicate with network 780 via network interface 756. For example, computer system 700 may receive information (such as a request or a response from another device) from network 780 in the form of one or more incoming packets at network interface 756 and memory 730 may store the incoming packets for subsequent processing. Computer system 700 may send information (such as a request or a response to another device) to network 780 in the form of one or more outgoing packets from network interface 756, which memory 730 may store prior to being sent. Processors 720 may access an incoming or outgoing packet in memory 730 to process it, according to particular needs.

Computer system 700 may have one or more input devices 766 (which may include a keypad, keyboard, mouse, stylus, etc.), one or more output devices 768 (which may include one or more displays, one or more speakers, one or more printers, etc.), one or more storage devices 770, and one or more storage medium 772. An input device 766 may be external or internal to computer system 700. An output device 768 may be external or internal to computer system 700. A storage device 770 may be external or internal to computer system 700. A storage medium 772 may be external or internal to computer system 700.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, floptical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 730 may include one or more computer-readable storage media embodying software and computer system 700 may provide particular functionality described or illustrated herein as a result of processors 720 executing the software. Memory 730 may store and processors 720 may execute the software. Memory 730 may read the software from the computer-readable storage media in mass storage device 730 embodying the software or from one or more other sources via network interface 756. When executing the software, processors 720 may perform one or more steps of one or more processes described or illustrated herein, which may include defining one or more data structures for storage in memory 730 and modifying one or more of the data structures as directed by one or more portions the software, according to particular needs. In addition or as an alternative, computer system 700 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

In particular embodiments, computer system 700 may include one or more Graphics Processing Units (GPUs) 724. In particular embodiments, GPU 724 may comprise one or more integrated circuits and/or processing cores that are directed to mathematical operations commonly used in graphics rendering. In some embodiments, the GPU 724 may use a special graphics unit instruction set, while in other implementations, the GPU may use a CPU-like (e.g. a modified ×86) instruction set. Graphics processing unit 724 may implement a number of graphics primitive operations, such as blitting, texture mapping, pixel shading, frame buffering, and the like. In particular embodiments, GPU 724 may be a graphics accelerator, a General Purpose GPU (GPGPU), or any other suitable processing unit.

In particular embodiments, GPU 724 may be embodied in a graphics or display card that attaches to the hardware system architecture via a card slot. In other implementations, GPU 724 may be integrated on the motherboard of computer system architecture. Suitable graphics processing units may include Advanced Micro Devices(r)AMD R7XX based GPU devices (Radeon(r) HD 4XXX, AMD R8XX based GPU devices (Radeon(r) HD 7XXX, Intel(r) Larabee based GPU devices (yet to be released), nVidia(r) 8 series GPUs, nVidia(r) 8 series GPUs, nVidia(r) 100 series GPUs, nVidia(r) 200 series GPUs, and any other DX11-capable GPUs.

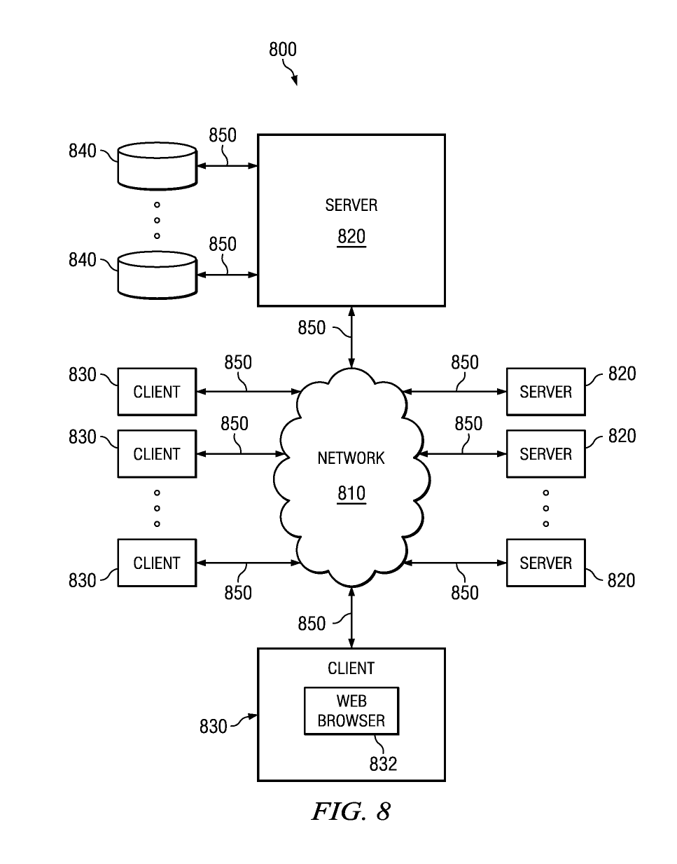

FIG. 8 illustrates an example network environment 800. This disclosure contemplates any suitable network environment 800. As an example and not by way of limitation, although this disclosure describes and illustrates a network environment 800 that implements a client-server model, this disclosure contemplates one or more portions of a network environment 800 being peer-to-peer, where appropriate. Particular embodiments may operate in whole or in part in one or more network environments 800. In particular embodiments, one or more elements of network environment 800 provide functionality described or illustrated herein. Particular embodiments include one or more portions of network environment 800. Network environment 800 includes a network 810 coupling one or more servers 820 and one or more clients 830 to each other. This disclosure contemplates any suitable network 810. As an example and not by way of limitation, one or more portions of network 810 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 810 may include one or more networks 810.

Links 850 couple servers 820 and clients 830 to network 810 or to each other. This disclsoure contemplates any suitable links 850. As an example and not by way of limitation, one or more links 850 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 850. In particular embodiments, one or more links 850 each includes an intranet, an extranet, a VPN, a LAN, a WLAN, a WAN, a MAN, a communications network, a satellite network, a portion of the Internet, or another link 850 or a combination of two or more such links 850. Links 850 need not necessarily be the same throughout network environment 800. One or more first links 850 may differ in one or more respects from one or more second links 850.

This disclosure contemplates any suitable servers 820. As an example and not by way of limitation, one or more servers 820 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, a server 820 includes hardware, software, or both for providing the functionality of server 820. As an example and not by way of limitation, a server 820 that operates as a web server may be capable of hosting websites containing web pages or elements of web pages and include appropriate hardware, software, or both for doing so. In particular embodiments, a web server may host HTML or other suitable files or dynamically create or constitute files for web pages on request. In response to a Hyper Text Transfer Protocol (HTTP) or other request from a client 830, the web server may communicate one or more such files to client 830. As another example, a server 820 that operates as a mail server may be capable of providing e-mail services to one or more clients 830. As another example, a server 820 that operates as a database server may be capable of providing an interface for interacting with one or more data stores (such as, for example, data stores 840 described below). Where appropriate, a server 820 may include one or more servers 820; be unitary or distributed; span multiple locations; span multiple machines; span multiple datacenters; or reside in a cloud, which may include one or more cloud components in one or more networks.

In particular embodiments, one or more links 850 may couple a server 820 to one or more data stores 840. A data store 840 may store any suitable information, and the contents of a data store 840 may be organized in any suitable manner. As an example and not by way or limitation, the contents of a data store 840 may be stored as a dimensional, flat, hierarchical, network, object-oriented, relational, XML, or other suitable database or a combination or two or more of these. A data store 840 (or a server 820 coupled to it) may include a database-management system or other hardware or software for managing the contents of data store 840. The database-management system may perform read and write operations, delete or erase data, perform data deduplication, query or search the contents of data store 840, or provide other access to data store 840.

In particular embodiments, one or more servers 820 may each include one or more search engines 822. A search engine 822 may include hardware, software, or both for providing the functionality of search engine 822. As an example and not by way of limitation, a search engine 822 may implement one or more search algorithms to identify network resources in response to search queries received at search engine 822, one or more ranking algorithms to rank identified network resources, or one or more summarization algorithms to summarize identified network resources. In particular embodiments, a ranking algorithm implemented by a search engine 822 may use a machine-learned ranking formula, which the ranking algorithm may obtain automatically from a set of training data constructed from pairs of search queries and selected Uniform Resource Locators (URLs), where appropriate.

In particular embodiments, one or more servers 820 may each include one or more data monitors/collectors 824. A data monitor/collection 824 may include hardware, software, or both for providing the functionality of data collector/collector 824. As an example and not by way of limitation, a data monitor/collector 824 at a server 820 may monitor and collect network-traffic data at server 820 and store the network-traffic data in one or more data stores 840. In particular embodiments, server 820 or another device may extract pairs of search queries and selected URLs from the network-traffic data, where appropriate.

This disclosure contemplates any suitable clients 830. A client 830 may enable a user at client 830 to access or otherwise communicate with network 810, servers 820, or other clients 830. As an example and not by way of limitation, a client 830 may have a web browser 832, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 830 may be an electronic device including hardware, software, or both for providing the functionality of client 830. As an example and not by way of limitation, a client 830 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 830 may include one or more clients 830; be unitary or distributed; span multiple locations; span multiple machines; span multiple datacenters; or reside in a cloud, which may include one or more cloud components in one or more networks.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of a social network system, it will apparent to one of ordinary skill in the art that the invention may be used with any electronic social network service and, even if it is not provided through a website. Any computer-based system that provides social networking functionality can be used in accordance with the present invention even if it relies, for example, on e-mail, instant messaging or other form of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a social network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising, by one or more computing systems:
accessing a viewport definition;
identifying regions of a global meta-space that intersect the viewport, wherein the identified regions are defined in terms of a first spatial partitioning algorithm;
identifying digital objects embedded in the identified regions;
creating, for each of the identified digital objects, a list of second spatial partitioning algorithm addresses, each address identifying a respective tile in a set of tiles contained in each of the identified digital objects;
creating, using a third spatial partitioning algorithm, a region model for the viewport, wherein the lists of tiles are regions in the region model;
generating a list of tiles to be rendered based on a stacking order of the digital objects and the global meta space; and
rendering the viewport from the list of tiles to be rendered.

2. The method of claim 1, wherein viewport is defined relative to global coordinates at the highest level pixel space.

3. The method of claim 1, wherein the second spatial partitioning algorithm is a quad tree.

4. The method of claim 1, wherein the first spatial partitioning algorithm is a region tree.

5. The method of claim 4, wherein the region tree is an R* tree.

6. The method of claim 1, wherein the third spatial partitioning algorithm is a region tree.

7. The method of claim 6, wherein the region tree is an R* tree.

8. The method of claim 1, wherein the first and third spatial partitioning algorithms are separate instances of an R* tree.

9. The method of claim 1, wherein the digital comprise regions of the global meta-space and regions of individual objects embedded in the global meta-space.

10. The method of claim 1, further comprising obtaining the boundary definitions of the objects during creation of the region model.

11. The method of claim 1, wherein iteratively generating a list of tiles to be rendered comprises:
beginning with the lowest level object:
a.) adding the regions of the current level object to the list;
b.) comparing list of regions to the boundaries of the overlying object via querying the region model;
c.) pruning out the occluded regions;
d.) incrementing the current region; and
repeating steps a-d until the second to highest-level object is reached.

12. The method of claim 1, wherein objects with larger pixel areas are assigned a lower level stacking order.

13. The method of claim 1, wherein the region model is created whenever the viewport or an object is moved or resized.

14. An apparatus comprising:
one or more processors;
one or more non-transitory computer-readable media containing instructions, the instructions operable, when executed by the one or more processors, to:
access a viewport definition;
identify regions of a global meta-space that intersect the viewport, wherein the identified regions are defined in terms of a first spatial partitioning algorithm;
identify digital objects embedded in the identified regions;
create, for each of the identified digital objects, a list of second spatial partitioning algorithm addresses, each address identifying a respective tile in a set of tiles contained in each of the identified digital objects;
create, using a third spatial partitioning algorithm, a region model for the viewport, wherein the lists of tiles are regions in the region model;
generate a list of tiles to be rendered based on a stacking order of the digital objects and the global meta space; and
render the viewport from the list of tiles to be rendered.

15. The apparatus of claim 14, wherein viewport is defined relative to global coordinates at the highest level pixel space.

16. The apparatus of claim 14, wherein the second spatial partitioning algorithm is a quad tree.

17. The apparatus of claim 14, wherein the first and third spatial partitioning algorithms are separate instances of an R* tree.

18. The apparatus of claim 14, wherein iteratively generating a list of tiles to be rendered comprises:
beginning with the lowest level object:
a.) adding the regions of the current level object to the list;
b.) comparing list of regions to the boundaries of the overlying object via querying the region model;
c.) pruning out the occluded regions;
d.) incrementing the current region; and
repeating steps a-d until the second to highest-level object is reached.

19. The apparatus of claim 14, wherein the region model is created whenever the viewport or an object is moved or resized.

20. A non-transitory computer-readable media containing instructions, the instructions operable, when executed by the one or more processors, to:
access a viewport definition;
identify regions of a global meta-space that intersect the viewport, wherein the identified regions are defined in terms of a first spatial partitioning algorithm;
identify digital objects embedded in the identified regions;
create, for each of the identified digital objects, a list of second spatial partitioning algorithm addresses, each address identifying a respective tile in a set of tiles contained in each of the identified digital objects;
create, using a third spatial partitioning algorithm, a region model for the viewport, wherein the lists of tiles are regions in the region model;
generate a list of tiles to be rendered based on a stacking order of the digital objects and the global meta space; and
render the viewport from the list of tiles to be rendered.
